(19) United States
(12) Patent Application Publication
(10) Pub. No.: US 2008/0231796 A1
(43) Pub. Date: Sep. 25, 2008

(54) NECKLACE-EYEGLASS SYSTEM

(75) Inventors: Deborah A. ZOULLAS, New York, NY (US); Elizabeth FARAUT, Pacific Palisades, CA (US)

Correspondence Address: HESLIN ROTHENBERG FARLEY & MESITI PC, 5 COLUMBIA CIRCLE, ALBANY, NY, 12203, US

(73) Assignee: LA LOOP, LLC, New York, NY (US)

(21) Appl. No.: 11/689,332

(22) Filed: Mar. 21, 2007

(51) Int. Cl. G02C 11/02

(52) U.S. Cl. 351/52; 351/51

(57) ABSTRACT

A necklace-eyeglass system includes a plurality of links each having a first shape. An eyeglass frame is connected to the plurality of links and includes a lens holding portion holding a lens in a lens opening thereof. The lens holding portion has a second shape. The first shape and the second shape are a same shape.

### CROSS-REFERENCE TO RELATED APPLICATIONS

This application relates to U.S. Design Application Ser. No. ______, filed _, (Attorney Docket No. 2202.032), entitled “Necklace”; U.S. Design Application Ser. No. ______, filed _, (Attorney Docket No. 2202.033), entitled “Necklace”; U.S. Design Application Ser. No. ______, filed _, (Attorney Docket No. 2202.034), entitled “Necklace”; and U.S. Design Application Ser. No. ______, filed _, (Attorney Docket No. 2202.035), entitled “Necklace”; the entire disclosures of which are incorporated herein by reference.

### FIELD OF THE INVENTION

The present invention relates to a necklace and, more particularly, to a necklace system which includes at least one eyeglass lens.

### BACKGROUND ART

Generally, people who wear eyeglasses remove and replace them frequently during the course of a day. When an eyeglass wearer removes his or her eyeglasses, it is usually desired to keep the eyeglasses close at hand in order to be able to replace them conveniently. Upon removing eyeglasses, therefore, eyeglass wearers frequently place the eyeglasses in a pocket of a shirt or coat, or hang the eyeglasses from a neck opening of a sweater or a blouse by inserting a temple piece of the eyeglasses down inside the garment. However, eyeglasses may fall from a shirt or coat pocket or from a neck opening of a sweater or blouse when the eyeglass wearer bends over, which is at best an annoyance and which can result in damage to the eyeglasses. In addition, certain styles of garments do not have pockets or neck openings suitable for holding eyeglasses.

Thus, a need exists for a necklace-eyeglass system which holds an eyeglass frame neatly and securely even as a wearer of the necklace-eyeglass system moves about.

### SUMMARY OF THE INVENTION

The present invention provides a necklace-eyeglass system which includes a plurality of links each having a first shape. An eyeglass frame is connected to the plurality of links and includes a lens holding portion holding a lens in a lens opening thereof. The lens holding portion has a second shape. The first shape and the second shape are a same shape.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention will be apparent from the following detailed description of preferred embodiments taken in conjunction with the accompanying drawings in which:

FIG. 1 is a perspective view of a necklace-eyeglass system in accordance with the present invention.

FIG. 2 is a front elevational view of the system of FIG. 1;

FIG. 3 is a top plan view of the system of FIG. 1;

FIG. 4 is a side view of the system of FIG. 1;

FIG. 5 is a perspective view of another embodiment of a necklace-eyeglass system in accordance with the present invention;

FIG. 6 is a perspective view of a further embodiment of a necklace-eyeglass system in accordance with the present invention;

FIG. 7 is a perspective view of another embodiment of a necklace-eyeglass system in accordance with the present invention; and

FIG. 8 is a perspective view of yet another embodiment of a necklace-eyeglass system in accordance with the present invention.

### DETAILED DESCRIPTION OF THE PREFERRED EMBODIMENT

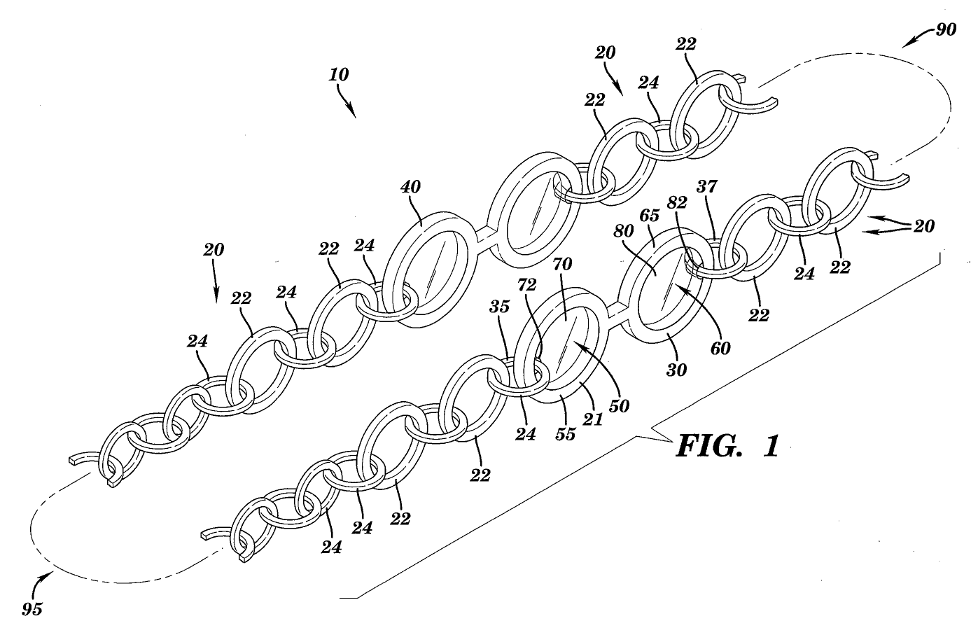

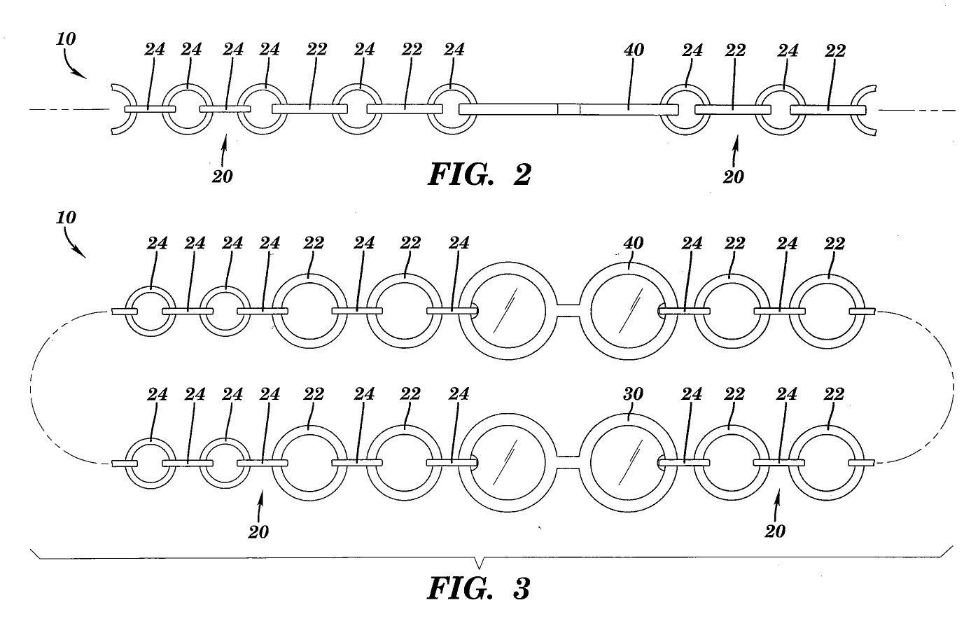

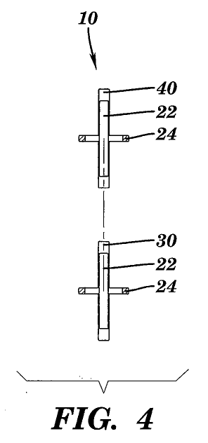

In accordance with the principles of the present invention, a necklace-eyeglass system is provided. In an exemplary embodiment depicted in FIG. 1, a necklace-eyeglass system 10 includes a plurality of links 20 connected to a first eyeglasses frame 30 and a second eyeglasses frame 40.

Links 20 could include links of varying sizes having faces (e.g., a circular face 21) of a same shape (e.g., faces in a shape of a circle, square, rectangle, oval, etc.) or having the same three-dimensional shape. The plurality of links could include a particular number of links depending on a desired length of a necklace and a size of each link. The necklace (i.e., links 20) could include links of the same size or different sizes. For example, as depicted in FIG. 1, links 20 could include larger links 22 and smaller links 24. As depicted, larger links 22 and smaller links 24 may alternate on a first end 90 of system 20, and a second end 95 may include only smaller links 24 except for two large links 22 which alternate with smaller links 24 adjacent each frame. Alternatively, the smaller and larger links may be interspaced differently or one or more other differently sized links may also be utilized. FIG. 1 discloses each end (i.e., first end 90 and second end 95) of system 10 being broken to show the plurality of links being of indeterminate length.

Eyeglass frames 30 and 40 could include lenses to aid the vision of a wearer (e.g., to correct near-sightedness (myopia) or farsightedness (presbyopia)). Both frames could include such lenses or only one of such frames could include such lenses. Although depicted as standard eyeglass frames absent the temple pieces, the frames could be shaped in any number of ways which allow such frames to hold one or more lenses.

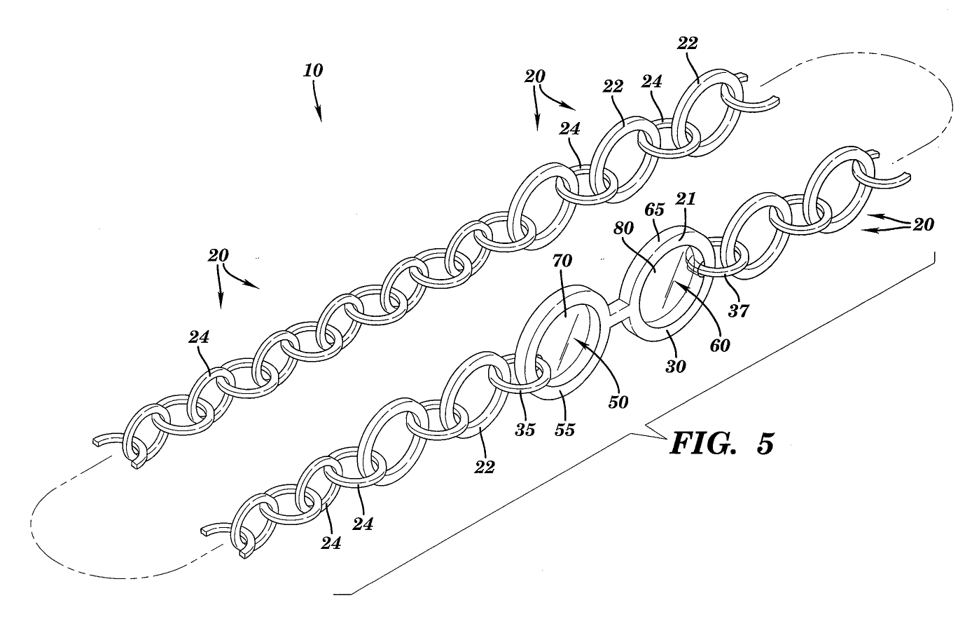

As depicted in FIG. 1, frame 30 is connected to a connecting link 35 and a second connecting link 37. Connecting link 35 extends through lens opening 50 of lens holder 55 and connecting link 37 extends through lens opening 60 of lens holder 65. Connecting link 35 is adjacent to a lens 70 and may pass through an opening 72 therein while connecting link 37 is adjacent to second lens 80 and may pass through an opening 82 therein. For example, lens 70 and lens 80 may be a different magnification or a different type (e.g., for near-sightedness or farsightedness) relative to each other. Also, one of the frames may be absent as depicted in FIG. 5 in which links 20 are connected to only frame 30 with additional links 20 replacing the length of frame 40.

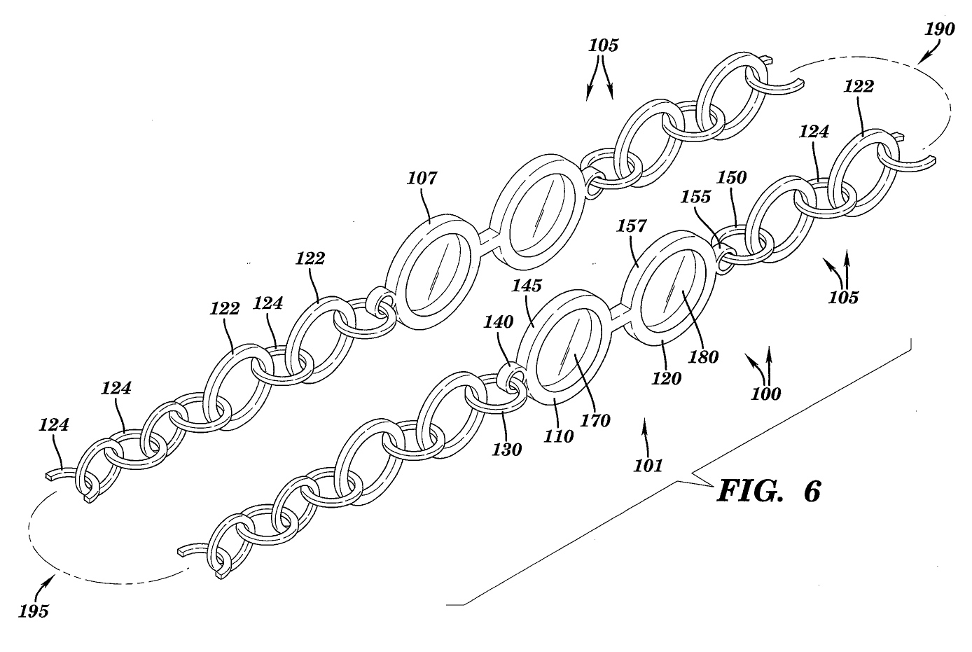

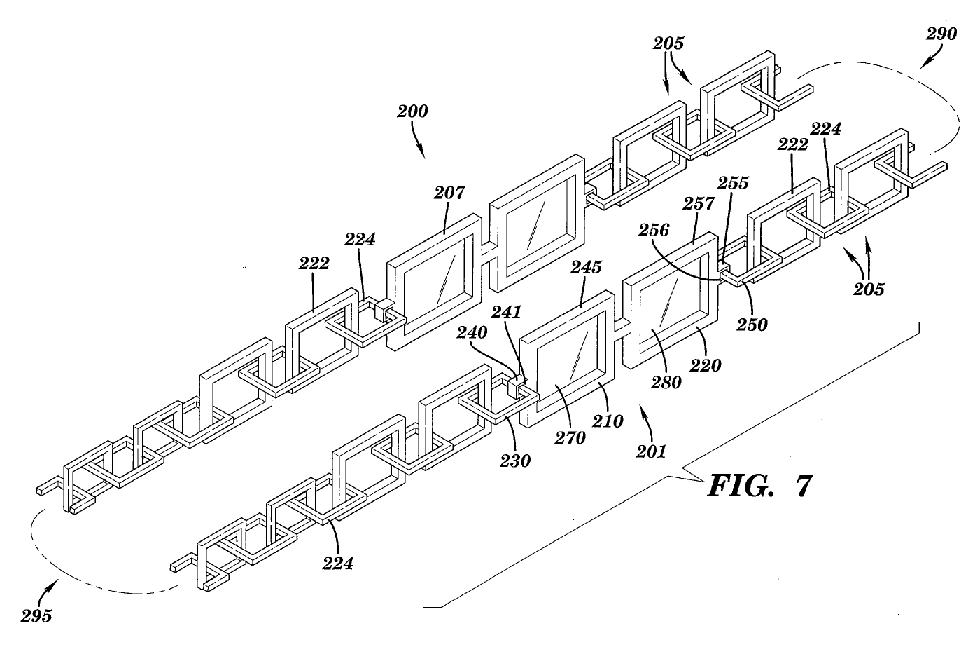

In another embodiment depicted in FIG. 6, a necklace-eyeglass system 100 includes an eyeglasses frame 101 having a lens holder 110 and second lens holder 120. Lens holder 110 may be connected to a connecting link 130 of a plurality of links 105 via a loop 140 formed in an outside surface 145 of lens holder 110. Similarly, lens holder 120 may be connected to a connecting link 150 via a loop 155 formed in an outside surface 157 of lens holder 120. The connecting links may connect to the frames by extending through the appropriate loop. The lens holders may hold lenses 170 and 180, which may be corrective lenses, sunglass lenses or another type of lens. As described above relative to FIG. 1, links 105 could include larger links 122 and smaller links 124. As depicted, larger links 122 and smaller links 124 may alternate on a first end 190 of system 100, and a second end 195 may include only smaller links 124 except for two larger links 122 which alternate with smaller links 124 adjacent each frame. Alternatively, the smaller and larger links may be interspaced differently or one or more other differently sized links may also be utilized. A second frame 107 may include one or more lenses as in frame 40 or it may lack such a lens. Further, in a another example (not shown), second frame 107 may be replaced by links, such as links 122 or links 124, or a combination thereof.

In yet a further embodiment depicted in FIG. 7, a necklace-eyeglass system 200 includes an eyeglasses frame 201 having a lens holder 210 and a second lens holder 220. Lens holder 210 may be connected to a connecting link 230 of a plurality of rectangular or square links 205 via a connecting structure 240 having a square or rectangular opening 241 formed in an outside surface 245 of lens holder 210. Similarly, lens holder 220 may be connected to a connecting link 250 via a connecting structure 255 having a square or rectangular opening 256 formed in an outside surface 257 of lens holder 220. The connecting links may extend through opening 241 and opening 256, respectively. The lens holders may hold lenses 270 and 280, which may be corrective lenses, sunglass lenses or another type of lens. As described above relative to FIG. 1, links 205 could include larger links 222 and smaller links 224. As depicted, larger links 222 and smaller links 224 may alternate on a first end 290 of system 200, and a second end 295 may include only smaller links 224 except for two large links 222 which alternate with smaller links 224 adjacent each frame. Alternatively, the smaller and larger links may be interspaced differently or one or more other differently sized links may also be utilized. A second frame 207 may include one or more lenses as in frame 40 or it may lack such a lens. Further, in another example (not shown) similar to FIG. 5, second frame 207 may be replaced by links such as links 222 or links 224, or a combination thereof.

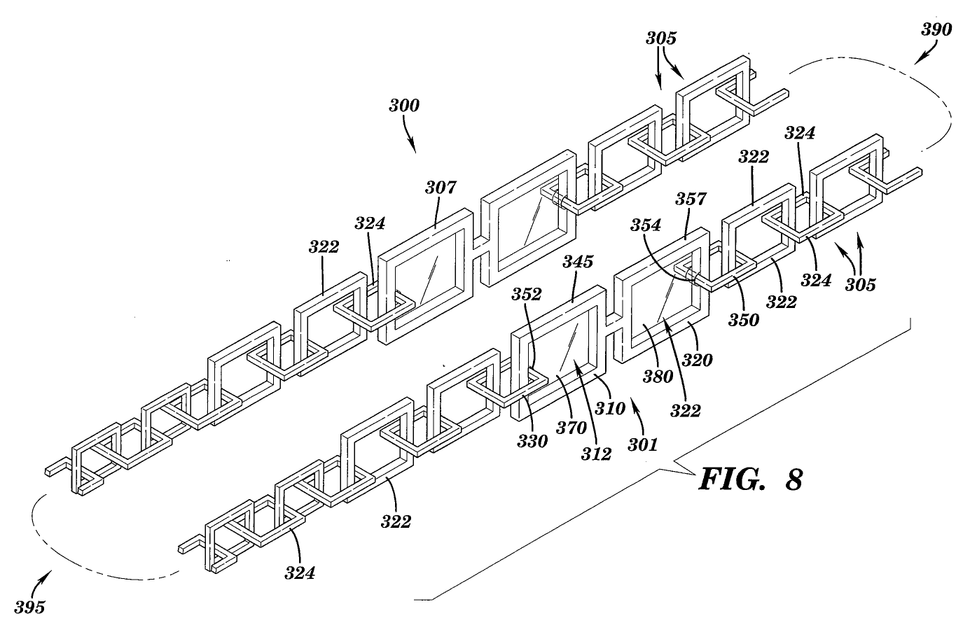

In a further example illustrated in FIG. 8, a necklace-eyeglass system 300 includes an eyeglasses frame 301 having a lens holder 310 and a second lens holder 320. The lens holders may hold lenses 370 and 380, which may be corrective lenses, sunglass lenses or another type of lens. Lens holder 310 may be connected to a connecting link 330 of a necklace having a plurality of rectangular or square links 305 via connecting link 330 extending through lens opening 312 of lens holder 310. Also, a connecting link 350 extends through lens opening 322 of lens holder 320 to connect connecting link 350 to lens holder 320. Connecting link 330 is adjacent to a lens 370 and may pass through an opening 352 therein while connecting link 350 is adjacent to second lens 380 and may pass through an opening 354 therein. As described above relative to FIG. 1, links 305 could include larger links 322 and smaller links 324. As depicted, larger links 322 and smaller links 324 may alternate on a first end 390 of system 300, and a second end 395 may include only smaller links 324 except for two larger links 322 which alternate with smaller links 324 adjacent each frame. Alternatively, the smaller and larger links may be interspaced differently or one or more other differently sized links may also be utilized. A second frame 307 may include one or more lenses as in frame 40 or it may lack such a lens. Further, in another example (not shown) similar to FIG. 5, second frame 307 may be replaced by links such as links 322 or links 324, or a combination thereof.

The links and eyeglass frames disclosed herein may be colored and sized such that there is little visual differentiation between the frames and links. For example, all the links (e.g., links 20, 105, 205, 305) depicted may be colored a same color, have a same coloring pattern and/or have a same texture as the corresponding eyeglass frame(s) (e.g., frames 10, 40, 101, 107, 201, 207, 301, 307) depicted therein. Further, the links and frames may be formed of a same or similar material such as metal, beads, plastic or other materials commonly used in eyeglass frames and jewelry. Further the connecting links (e.g., links 35, 37, 130, 150, 230, 250, 330, 350) of the necklaces described may be connected to the frame in any number of ways including interlocking loops, adhesives, screws, fasteners or other means for connecting. Such connection between the connecting links and the frames may allow movement between the connecting links and the frames or such connection may be a fixed connection inhibiting or preventing such movement. Also, the connecting links may be connected to the frames at a point equidistant from the top and bottom of such frame as depicted in the figures. Alternatively, the connecting links could be connected to the frames at other points on the frames, such as being attached to the bottoms or tops of the lens holders thereof. Moreover, the connecting links themselves may interlock with each other as depicted in the figures or they may be connected to one another in other ways such that they do not interlock. For example, the links may be moveable relative to each other as depicted in the figures or they may be fixed relative to one another. For example, outside surfaces of the links could also be connected to each other.

Moreover, each frame (e.g., frames 10, 40, 101, 107, 201, 207 301, 307) described herein may include more or less lens holders therein. For example, a frame could include one, three, or four lens holders each of which could have a same type lens or a different type lens therein relative to the other lens holders of a particular frame. The lenses may be corrective or non-corrective (e.g., sunglass) lenses. Further, one or more lens holder(s) may lack lenses. Also, as depicted the frames do not include temple pieces to allow a user to wear or support the frames on the user's ears. However, such frames could include such temple pieces and preferably the necklace portion (i.e., links) would be attached to the lens holder(s) and not to the temple pieces in such an example.

The links (e.g., links 20, 105, 205, 305) described could be prisms having two substantially identical faces (e.g., square, triangular, hexagonal, octagonal, oval, serpentine, or other polygons) connected by sides having substantially rectangular faces. Such faces may be substantially parallel to one another. Also the links could be polyhedrons having substantially identical faces (e.g., square, triangular, hexagonal, octagonal) connected by curved or rounded sides. Also, the figures depict the links (e.g., links 20, 105, 205, 305) being broken on each end (e.g., ends 90, 95, 190, 195, 290, 295, 390, 395) of the systems illustrated and a dotted line showing that the necklaces are of indeterminate length such that a greater or lesser number of links may be utilized in such a necklace for a particular purpose, e.g., to fit users of different sizes. The cross-sections of the links could be rectangular, square, or in the shape of other polygons, and include parallel sides and rounded top and bottom portions, for example. Also, jewelry chains or strings of beads of a wide variety of styles may be used for the necklace (i.e., links) of the necklace-eyeglass system of the invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

1. A necklace-eyeglass system, the system comprising:
a plurality of links, each of said plurality of links having a first shape;
an a first eyeglass frame connected to said plurality of links, said frame comprising a lens holding portion holding a lens in a lens opening thereof, said lens holding portion having a second shape, said first shape and said second shape being a same shape.

2. The system of claim 1 wherein said plurality of links comprises links of at least two different sizes and having the same shape.

3. The system of claim 1 wherein a connecting link of said plurality of links is connected to an exterior surface of said lens holding portion opposite said lens relative to said lens holding portion.

4. The system of claim 3 wherein said connecting link is directly connected to said exterior surface of said lens holding portion.

5. The system of claim 3 wherein said exterior surface comprises a connecting structure bounding an opening and said connecting link extends through said opening to connect said connecting structure to said lens holding portion.

6. The system of claim 1 wherein a connecting link of said plurality of links is connected to said lens holding portion such that said connecting link interlocks with said lens holding portion and is received in said lens opening and is adjacent said lens.

7. The system of claim 6 wherein said lens holding portion holds a lens having an opening and said connecting link extends through said opening.

8. The system of claim 1 wherein said plurality of links and said lens holding portion comprise a plurality of rings.

9. The system of claim 1 wherein said plurality of links and said lens holding portion comprise a plurality of rectangular shapes.

10. The system of claim 1 wherein said plurality of links and said lens holding portion comprise a plurality of quadrilateral polyhedrons.

11. The system of claim 10 wherein each of said plurality of quadrilateral polyhedrons comprise two rectangular faces connected by rounded edges.

12. The system of claim 1 further comprising a second eyeglass frame connected to said plurality of links, said first frame and said second frame each comprising a plurality of lens openings.

13. The system of claim 12 wherein said plurality of lens openings of said first frame comprise a first type of lens and said plurality of lens openings of said second frame comprise a second type of lens.

14. The system of claim 1 wherein a connecting link of said plurality of links is moveably connected to said lens holding portion.

15. The system of claim 1 wherein said plurality of links and said frame comprise a same coloring.

16. The system of claim 1 wherein said plurality of links and said frame comprises a same texture.

17. The system of claim 1 wherein said plurality of links and said frame avoid connection with a temple piece of an eyeglasses frame.

18. The system of claim 1 wherein said plurality of links connects to said eyeglass frame at a location substantially equidistant from a top of said frame and a bottom of said frame.

19. The system of claim 1 wherein said eyeglass frame comprises a second lens holding portion connected to said lens holding portion by a bridge, said bridge being located equidistant between a top and a bottom of each of said lens holding portion and said second lens holding portion, and wherein said plurality of links are connected to each of said lens holding portion and said second lens holding portion at a point equidistant from a top and a bottom of each of said lens holding portion and said second lens holding portion.
